(19) United States
(12) Patent Application Publication
(10) Pub. No.: US 2018/0279587 A1
(43) Pub. Date: Oct. 4, 2018

(54) Special Fish Tank System to Raise and Sell Saltwater Fish

(71) Applicant: Kenneth Ray Compton, Indianapolis, IN (US)

(72) Inventor: Kenneth Ray Compton, Indianapolis, IN (US)

(21) Appl. No.: 15/790,184

(22) Filed: Oct. 23, 2017

Related U.S. Application Data
(60) Provisional application No. 62/480,329, filed on Mar. 31, 2017.

(51) Int. Cl. A01K 63/00; A01K 63/04

(52) U.S. Cl. CPC A01K 63/003; A01K 61/10; A01K 63/04

(57) ABSTRACT

A special fish tank system to commercially raise and to sell salt-water fish which uses tidal changes to replenish the seawater and remove stale water from the fish raising environment. This system also known as fish-farming or mariculture is for the raising of fish as a food product. It includes a water tight tank, a protective berm to keep out unwanted high waters and storms, a cover, a truck approach, an influent pipe that runs from the bottom of the ocean to the tank an elevation drop wherein the high tide permits and replenishes new seawater to the tank through tidal shifts and an effluent pipe with a cage to contain the fish. Optional water filtering devices including a bacteria remover, an electro coagulation machine, and a Seawater Reverse Osmosis Systems (SWRO) are anticipated.

### CROSS-REFERENCE TO RELATED APPLICATIONS

This application claims the benefit of United States Provisional patent application with Ser. No. 62/480,329 filed Mar. 31, 2017, by Kenneth Ray Compton and entitled “Special fish tank system to raise and sell saltwater fish”.

### FIELD OF INVENTION

This invention relates to a special fish tank system to commercially raise and to sell salt-water fish. This tank system relates to a manner for cultivating aquatic saltwater organisms. In particular, the invention concerns a tank system onshore using tidal changes to replenish the seawater and remove stale water from the fish raising environment. The tank system has been developed primarily for cultivating fish and will therefore be described in this context. Further the invention relates to a fish tank for intensive fish fattening, which has the water exchange for feeding air and/or oxygen to the fish water and which is preferably designed as a long tank or a system consisting of several long fish tanks. This system relates to salt water “fish-farming” or mariculture process for the raising of fish as a food product. Also, it relates to a unique fish-farming process whereby fishes can be economically produced on a large scale basis with minimal dependence on environmental conditions.

### FEDERALLY SPONSORED RESEARCH

None.

### SEQUENCE LISTING OR PROGRAM

None.

### BACKGROUND-FIELD OF INVENTION and PRIOR ART

As far as known, there are no special fish tank system to commercially raise and to sell salt-water fish or the like. It is believed that this product is unique in its design and technologies.

### BACKGROUND

Fish cultivating systems are known. Such systems include cage and pond cultivating systems. Disadvantages with these types of systems include that they do not allow for total monitoring and control of cultivation conditions, they do not enable the stocked fish to be closely monitored for general growth, hygiene and disease, nor do they allow for the easy handling of fish stock.

An ever-increasing demand for food fishes and for the protein derived therefrom has given rise to increased interest on the part of commercial concerns in the “farming” or raising of all types of fishes as a food source. However, although a significant amount of information has been published concerning fresh water “farming,” there has been very little reported concerning the raising of salt water type fishes. This is probably attributable to the significant difficulties in isolating and controlling the environmental conditions of the saltwater fish as compared with fresh water fish. Since fish living in natural ocean or sea waters are often subjected to radical and sometimes violent environmental changes, in order to provide a reliable and economical salt water fish farm, it is essential to remove the dependency of the mariculture fish population from such natural conditions and to provide an optimum artificially controlled environment which will permit the survival of a maximum quantity of the fish and will optimize the development of the fish in terms of food value and taste. Heretofore, however, no successful technique has been devised which will effectively remove the dependency of the fish population on all of the critical environmental conditions, and hence, heretofore, no economical mariculture has been devised which can be adapted for use on a large commercial scale.

### PRIOR ART

A diligent novelty search was completed but the prior are revealed no applications or patents that anticipated or rendered obvious the Kenneth Ray Compton saltwater fish raising tank to commercially raise and to sell salt-water fish. Prior art found is: A patent application by Stence J R entitled—Method for Raising Aquatic Animals and published as US2006/0065204. A U.S. Pat. No. 7,287,488 issued to Taylor et al. in 2007 and entitled—Raceway for Cultivating Aquatic Organisms. A Japanese patent No. JP201221335 called an Apparatus for Onshore Cultivation of Marine Alga and Onshore Cultivation Method for Marine Alga issued to Hisakazu Mizota in 2012. A U.S. Pat. No. 6,978,735 named Artificial Fish Habitat and issued to Yeager in 2005. A further U.S. Pat. No. 6,491,473 entitled Precast Modular Concrete Shapes and methods of Installation to Form Shoreline Stabilization, Marine and Terrestrial Structures. This was issued to Veazey in 2002. In 1994, a U.S. Pat. No. 5,299,530 was issued to Mukadam et al. and called a Sumergible Fish Cage. A U.S. Pat. No. 4,951,606 named a Fish Tank for Intensive Fish Fattening and Process for Operating Such a Fish Tank was provided to Hartung in 1990. Another U.S. Pat. No. 4,212,268 was entitled Aquaculture Habitat and went to Chapman in 1980. In 1977 a U.S. Pat. No. 4,029,050 issued to Genest called a Fish Handling Apparatus. A 1975 U.S. Pat. No. 3,900,004 named an Automatic Circulating Hatchery issued to Goldman et al. and a U.S. Pat. No. 3,765,372 entitled Process and Apparatus for Mariculture Production issued to Moe, Jr et al. in 1973.

### Problem Solved

A need exists, therefore, for a mariculture or salt water fish farming process whereby the fish are grown and spawned, raised to a viable size, in which a controlled environment is used to remove dependence on natural environmental conditions. This type of system has now been devised, which is believed to be suitable for the growing of a wide variety of estuarine fishes with only slight variations in environmental conditions depending upon the particular species. In discussing this invention, however, it should be recognized that this invention can be practiced with any of the large variety of the type fishes including: salt water catfish, mullet, sea trout, grunts, flounder, porgies, tilapia, snapper, groupers, and many more salt water fishes and seafood creatures. All this is done in a biological equilibrium with the special fish tank system 30 to commercially raise and to sell salt-water fish.

### SUMMARY OF THE INVENTION

This invention is a saltwater fish raising tank for all types of salt-water fish and seafood. Taught here are the ways to economically provide a salt-water tank system close to an ocean or gulf to more efficiently raise commercial fish for consumer consumption.

The preferred embodiment a saltwater fish raising tank 30 that is comprised of: A special fish tank system that is comprised of: (a) a tank with water tight walls, the tank having a sloped bottom, a rearward end wall that is farthest away from the shore, a shoreward end wall nearest the shore, a pair of longitudinal wall along each side of the tank; (b) a protection berm that encircles the tank with an interior tank side and an exterior shore and surrounding area side, the berm further comprising a truck approach and service workspace area between the tank and the berm and at least one drain between the tank side and shore side of the berm; (c) an influent pipe that runs from the offshore bottom of the ocean to the tank, the entry end of the influent pipe in the offshore bottom of the ocean having a cage, an elevation drop, a section that runs parallel to the sloped tank bottom, and a cage and back flow valve at the farthest end of the tank near the rearward end wall of the tank, wherein the high tide permits and replenishes new seawater to the tank through tidal shifts; (d) an effluent pipe with a cage, the pipe runs from the tank near the shoreward end wall, through the berm, and through a wye and backflow valve to reconnect with the ocean influent pipe and return the old water from the tank by means of the tidal shift at low tide; and (e) a trough and a sump near the lower part of the sloped tank floor and near the shoreward end wall of the tank to provide a configuration to trap and remove debris, fish excrement, wasted food etc. from the tank and wherein the return water a low tide flushes the waste matter to the trough wherein the special fish tank system is used to economically and efficiently raise for commercially for sale salt-water fish and seafood. Optional water filtering devices including a bacteria remover, an electro coagulation machine, and a Seawater Reverse Osmosis Systems (SWRO) are anticipated.

The newly invented special saltwater fish raising tank may be manufactured at one tank or multiple tank systems. It also features various options with more environmental controls of the system.

### Objects and Advantages

There are several objects and advantages of the special fish tank system to raise and sell salt-water fish. There are currently no known saltwater fish raising tank systems that are effective at providing the objects of this invention.

The special fish tank system to raise and sell salt-water fish has various advantages and benefits:

TABLE A
Advantages and Benefits

| Item | Advantages |
|---|---|
| 1 | Uses ocean tides to exchange water in the tank |
| 2 | Provides fresh seawater to raised sea fish and |
| | crustaceans |
| 3 | Can be grouped with several tank systems to |
| | provide synergies in initial installation costs |
| | and operating costs |
| 4 | Can have an optional cover to keep out predator |
| | birds and mammals |
| 5 | Has trough and sumo system to remove debris and |
| | waste products |
| 6 | Can have an optional bacteria and slime removing |
| | device |
| 7 | Can have an optional metals removing device |
| 8 | Uses reduced labor and energy by preferred |
| | configuration shown |

Finally, other advantages and additional features of the present saltwater fish raising tank system will be more apparent from the accompanying drawings and from the full description of the device. For one skilled in the art of devices and systems for raising commercial fish and seafood, it is readily understood that the features shown in the examples with this product are readily adapted to other types of fish rising systems and devices.

### DESCRIPTION OF THE DRAWINGS—FIGURES

The accompanying drawings, which are incorporated in and constitute a part of this specification, illustrate an embodiment of the special fish tank system to raise and sell salt-water fish that is preferred. The drawings together with the summary description given above and a detailed description given below serve to explain the principles of the saltwater fish raising tank system. It is understood, however, that the special fish tank system to raise and sell salt-water fish is not limited to only the precise arrangements and instrumentalities shown.

FIG. 1 is a sketch of the special fish tank system to raise and sell salt-water fish from a generally Top View with components and features noted.

FIG. 2 is a sketch of a sectional view A-A of the saltwater fish raising tank system from a generally Side View with components and features noted.

FIG. 3 is a sketch of a sectional view B-B of the saltwater fish raising tank from a generally End View with components and features noted.

FIG. 4 is a sketch of the saltwater fish raising tank showing the ocean view of the influent pipe.

FIG. 5 A is a sketch of the special fish tank system to raise and sell salt-water fish showing a layout of five systems, for example, placed together to save on construction and operation synergies. FIG. 5 B is a sketch of the special fish tank system with multiple tanks having a common berm.

FIG. 6 shows a sketch of an optional Bacteria/Slime Reducer for the special fish tank system to raise and sell salt-water fish.

FIG. 7 shows a sketch of an optional Seawater Reverse Osmosis Systems (SWRO) for the special fish tank system to raise and sell salt-water.

FIGS. 8 A and 8 B show sketches of an optional Electro Coagulation system to remove metals from a Top View for the special fish tank system to raise and sell salt-water fish.

FIGS. 9 A and 9 B are sketches of Mock-up Piping for the saltwater fish raising tank.

FIGS. 10 A through 10 D are sketches of the Prototype Model.

### DESCRIPTION OF THE DRAWINGS—REFERENCE NUMERALS

The following list refers to the drawings:

TABLE B
Reference numbers

| Ref | |
|---|---|
| # | Description |
| 30 | special fish tank system 30 to raise and sell salt- |
| | water fish |
| 31 | prototype model 31 special fish tank system 30 to |
| | raise and sell salt-water fish |
| 32 | mock-up piping 32 of special fish tank system 30 to |
| | raise and sell salt-water fish |
| 35 | main fish tank 35 as an example and not as a |
| | limitation 100 feet wide by 300 feet long and 14 to |
| | 16 feet deep with a minimum 12 feet below high tide |
| | and 8 feet or more below low tide with a minimum 2 |
| | feet above shore line at 200 feet from high tide |
| | line |
| 35A | tank bottom, sloped from end farthest from shore |
| | downward to sump pit 37 collection trough 36 |
| 355 | tank 35 shoreward end wall 35S nearest the shore S |
| 35R | tank 35 rearward end wall 35R farthest away from |
| | the shore S |
| 35L | tank 35 wall 35L longitudinal wall along each side |
| | of tank |
| 36 | collection trough 36 |
| 37 | sump pit 37 |
| 39 | influent inclined pipe 44 support 39 from tank 35 |
| | inclined bottom 35A |
| 40 | intake/screen and trap turn down 40 to optimum |
| | depth for temperature and oxygen level |
| 41 | ocean and floor supports and anchors 41 to secure |
| | piping to floor of ocean |
| 42 | influent pipe 42 of fish tank system 30 |
| 42C | influent pipe 42C of fish tank system 30 after |
| | electro coagulation 80 or after Seawater Reverse |
| | Osmosis Systems (SWRO) 90 |
| 43 | influent pipe drop 43 to tank bottom 35A |
| 44 | influent inclined pipe 44 on inclined slope 35A on |
| | bottom and to the rear of tank 35R |
| 45 | supply or influent backflow valve/flap 45 and cage |
| | 45A |
| 46 | return pipe cage 46 |
| 47 | return pipe upturn 47 |
| 48 | return wye 48 |
| 49 | return backflow valve 49 |
| 50 | return pipe 50 |
| 60 | berm 60 |
| 61 | truck approach 61 |
| 62 | drain 62 between tank 35 and berm 60 |
| 63 | cover posts 63 |
| 64 | truck access area 64 between berm 60 and tank 35 |
| 65 | optional cover 65 |
| 66 | cover/roof membrane or roof 66 |
| 67 | optional side screens 67 |
| 70 | Bacteria/Slime Reducer 70 |
| 71 | cascade/step 71 to divert and spread water |
| 75 | power supply 75 |
| 77 | Ultra Violet, High Intensity Narrow Spectrum, |
| | and/or UV Germicidal Irradiation Lights 77 |
| 80 | Optional Electro Coagulation metals removal system |
| | 80 |
| 81 | plate scraper 81 |
| 82 | plate scraper support 82 |
| 83 | Electrolysis dual pair of electrodes Anode and |
| | cathode) Plate System 83 |
| 84 | structural support 84 or installation tank (in |
| | ground/no pump; above ground-pump) |
| 88 | airlock relief vent 88 on at high point on influent |
| | pipe 42C |
| 90 | Seawater Reverse Osmosis Systems (SWRO) 90 |
| 92 | Natural coral 92 transplanted and grown in the tank |
| | for enhanced habitat |
| 95 | Ocean 95 |
| 96 | common berm 60 layout 96 with multiple tanks 35 |
| S | shoreline at high tide S |

### DETAILED DESCRIPTION OF PREFERRED EMBODIMENT

This invention relates to a special fish tank system to commercially raise and to sell salt-water fish. This tank system relates to a manner for cultivating aquatic saltwater organisms. In particular, the invention concerns a tank system onshore using tidal changes to replenish the seawater and remove stale water from the fish raising environment. The tank system has been developed primarily for cultivating fish and will therefore be described in this context. Further the invention relates to a fish tank for intensive fish fattening, which has the water exchange for feeding air and/or oxygen to the fish water and which is preferably designed as a long tank or a system consisting of several long fish tanks. This system relates to salt water “fish-farming” or mariculture process for the raising of fish as a food product. Also, it relates to a unique fish-farming process whereby fishes can be economically produced on a large scale basis with minimal dependence on environmental conditions.

The advantages for the special fish tank system 30 to raise and sell salt-water fish are listed above in the introduction. Succinctly the benefits are that the device:
Uses ocean tides to exchange water in the tank
Provides fresh seawater to raised sea fish and crustaceans
Can be grouped with several tank systems to provide synergies in initial installation costs and operating costs
Can have an optional cover to keep out predator birds and mammals
Has trough and sumo system to remove debris and waste products
Can have an optional bacteria and slime removing device
Can have an optional metals removing device
Uses reduced labor and energy by preferred configuration shown

The preferred embodiment a special fish tank system 30 that is comprised of: A special fish tank system 30 that is comprised of: (a) a tank 35 with water tight walls, the tank 35 having a sloped bottom 35A, a rearward end wall 35R that is farthest away from the shore S, a shoreward end wall 35S nearest the shore S, a pair of 35L longitudinal wall 35L along each side of the tank 35; (b) a protection berm 60 that encircles the tank with an interior tank side and an exterior shore and surrounding area side, the berm 60 further comprising a truck approach 61 and service workspace area 64 between the tank 35 and the berm 60 and at least one drain 62 between the tank side and shore side of the berm 60; (c) an influent pipe 42 that runs from the offshore bottom of the ocean 95 to the tank 35, the entry end of the influent pipe 42 in the offshore bottom of the ocean having a cage 40, an elevation drop 43, a section 42C that runs parallel to the sloped tank bottom 35A, and a cage 45 and back flow valve 45A at the farthest end of the tank 35 near the rearward end wall 35R of the tank, wherein the high tide permits and replenishes new seawater to the tank through tidal shifts; (d) an effluent pipe 50 with a cage 46, the pipe 50 runs from the tank 35 near the shoreward end wall 35S, through the berm 60, and through a wye 48 and backflow valve 49 to reconnect with the ocean influent pipe 42 and return the old water from the tank by means of the tidal shift at low tide; and (e) a trough 36 and a sump 37 near the lower part of the sloped tank floor 35A and near the shoreward end wall 35S of the tank 35 to provide a configuration to trap and remove debris, fish excrement, wasted food etc. from the tank 35 whereby the return water a low tide flushes the waste matter to the trough 36 wherein the special fish tank system 30 is used to economically and efficiently raise for commercially for sale salt-water fish and seafood. Optional water filtering devices including a bacteria remover, an electro coagulation machine, and a Seawater Reverse Osmosis Systems (SWRO) are anticipated.

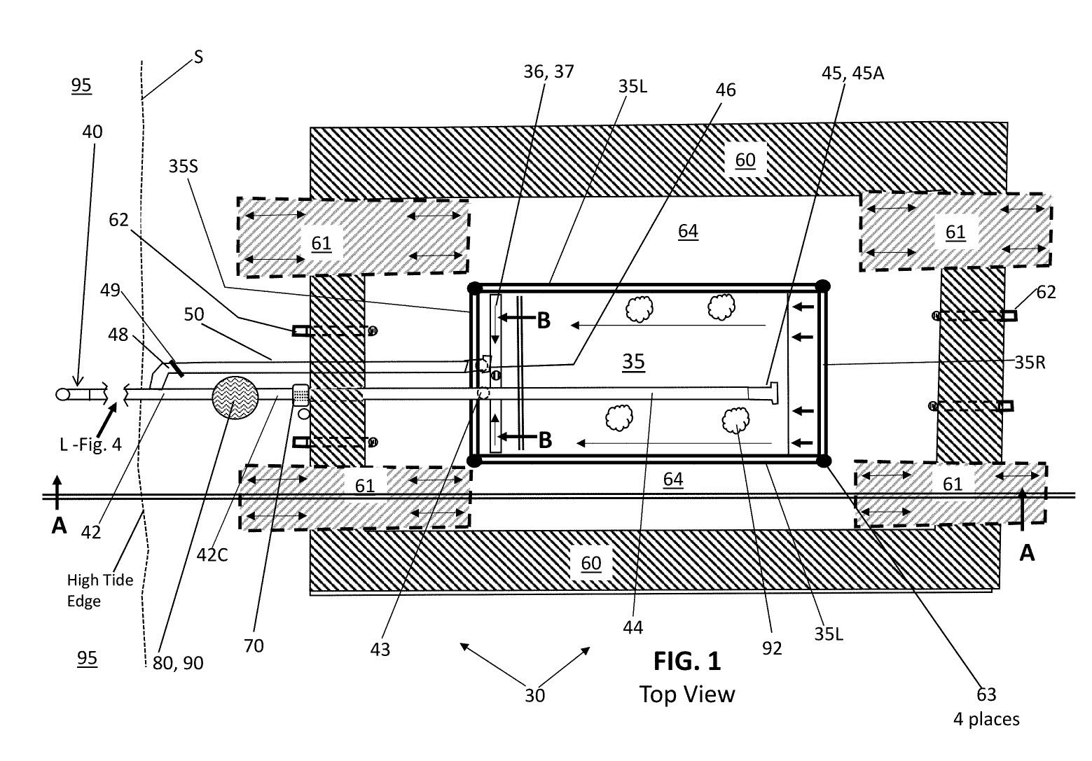

There is shown in FIGS. 1-10 a complete description and operative embodiment of the saltwater fish raising tank system 30. In the drawings and illustrations, one notes well that the FIGS. 1-10 demonstrate the general configuration and use of this system. The various example uses are in the operation and use section, below.

The accompanying drawings, which are incorporated in and constitute a part of this specification, illustrate an embodiment of the saltwater fish raising tank system 30 that is preferred. The drawings together with the summary description given above and a detailed description given below serve to explain the principles of the saltwater fish raising tank system 30. It is understood, however, that the special fish tank system 30 to raise and sell salt-water fish is not limited to only the precise arrangements and instrumentalities shown. Other examples of fish tank and fish raising systems and uses are still understood by one skilled in the art of fish raising devices and systems to be within the scope and spirit shown here.

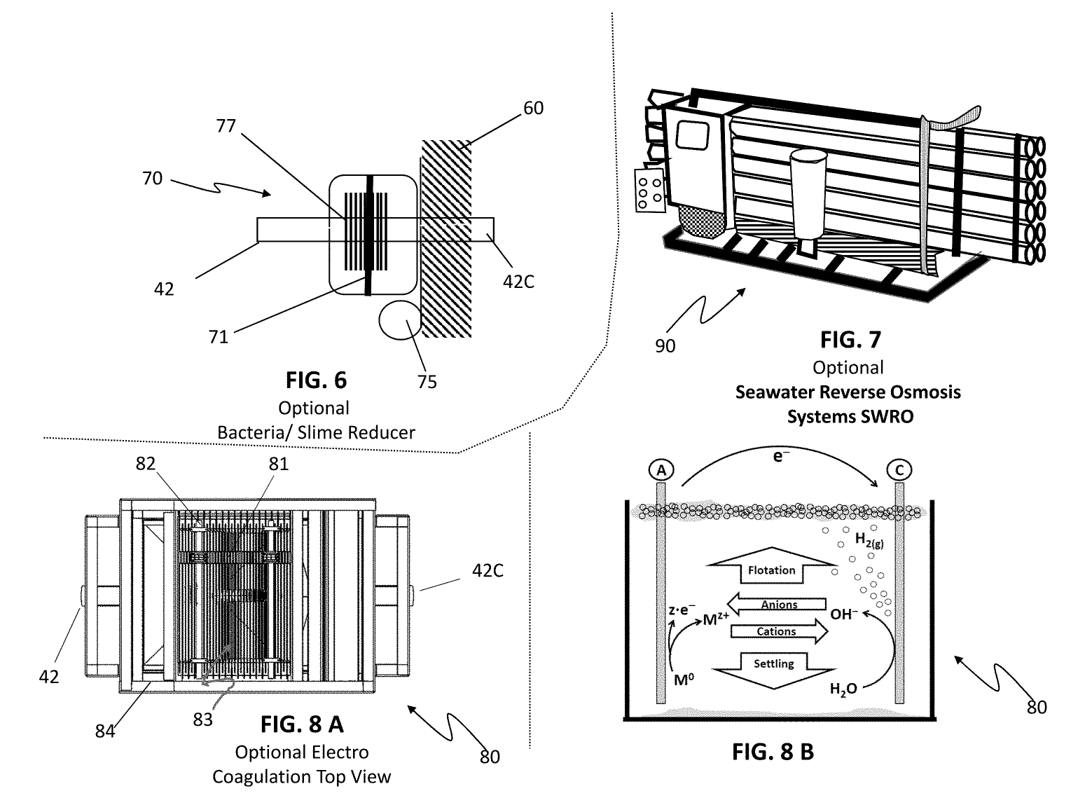

FIG. 1 is a sketch of the special fish tank system 30 to raise in order to commercially sell salt-water fish and seafood. The drawing is generally from a Top View with components and features noted. The components and features shown are: a special fish tank system 30 in which to raise and sell salt-water fish; the main fish tank 35 as an example and not as a limitation approximately 100 feet wide by 300 feet long and essentially 14 to 16 feet deep, with a minimum 12 feet of the tank below high tide and 8 feet of the depth (or more) below low tide—and with a minimum 2 feet of the tank walls above shore line at 200 feet away from the shoreline 5 at high tide; the tank 35 shoreward end wall 35S nearest the shore S; the tank 35 rearward end wall 35R and farthest away from the shore S; the tank 35 walls 35L which are longitudinal walls along each side of tank and run between the end walls 35S and 35R; a collection trough 36 for securing the waste materials (feed, excrement, etc.) washed down from the tank floor 35A; a sump pit 37 (anticipated to have a draining pipe and pump) in the trough 36; an intake/screen and trap turn down 40 to optimum depth for temperature and oxygen level in the ocean 95, the screen keeps trash, ocean plants and other fish and sea creatures from entering the pipes 42 to the tank 35; the influent pipe 42 of fish tank system 30; the influent pipe 42C of fish tank system 30 after electro coagulation 80 or after Seawater Reverse Osmosis Systems (SWRO) 90; an influent pipe drop 43 to tank bottom 35A; the influent inclined pipe 44 on inclined slope 35A on bottom and sloping up to the to the rearward end wall of tank 35R; the supply or influent pipe backflow valve/flap 45 and cage 45A; a cage 46 for the return pipe; a wye 48 in the return pipe 50; the backflow valve 49 in the return pipe 50; the return pipe 50; a protection berm 60 around the tank 35; a moderately sloped truck approach 61; a series of drains 62 between tank 35 and berm 60; a set of at least four (4) cover posts 63 to support a roof/cover 66 and side screens 67; a truck access area 64 between berm 60 and tank 35 which allows proximate access to the tank for loading and unloading fish, supplies, etc. and completing maintenance; a bacteria/slime Reducer 70 (described below in FIG. 6); a cascade/step 71 to divert and spread water in the reducer 70; an Optional Electro Coagulation metals removal system 80 (described below in FIG. 8); a Seawater Reverse Osmosis Systems (SWRO) 90 (described below in FIG. 7); Natural coral 92 transplanted and grown in the tank for enhanced habitat; the Ocean 95; and the shoreline at high tide 5.

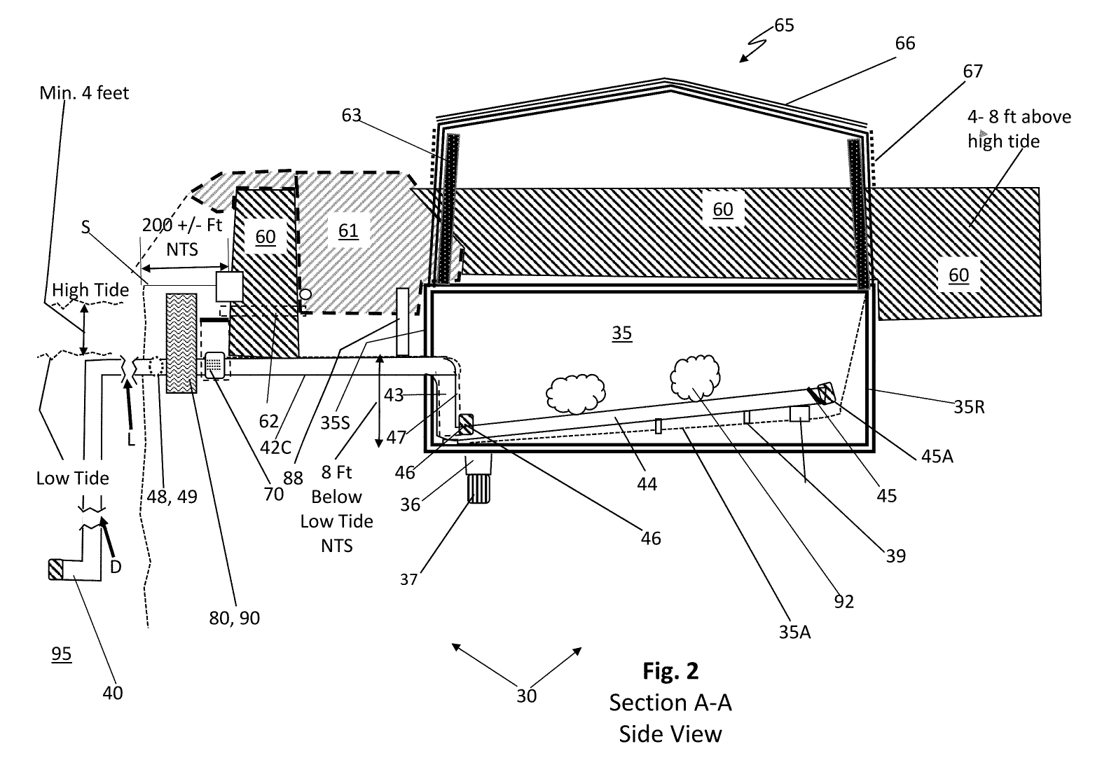

FIG. 2 is a sketch of a sectional view A-A of the fish tank system 30. This drawing is generally from a Side View with components and features noted. Many of the components are now seen from an elevated position. Depicted in this view is: a special fish tank system 30 in which to raise and sell salt-water fish; the main fish tank 35 as an example and not as a limitation approximately 100 feet wide by 300 feet long and essentially 14 to 16 feet deep, with a minimum 12 feet of the tank below high tide and 8 feet of the depth (or more) below low tide—and with a minimum 2 feet of the tank walls above shore line at 200 feet away from the shoreline 5 at high tide; the tank being constructed with water tight walls such as reinforced concrete, masonry block, precast concrete, steel with watertight liners, an earthen work with watertight liners, or the like; the tank bottom 35A, sloped from end farthest end from shore 35R downward to sump pit 37 and collection trough 36; the tank 35 shoreward end wall 35S nearest the shore S; the tank 35 rearward end wall 35R farthest away from the shore S; a collection trough 36 for securing the waste materials (feed, excrement, etc.) washed down from the tank floor 35A; a sump pit 37 (anticipated to have a draining pipe and pump) in the trough 36, wherein the trough 36 and sump 37 near the lower part of the sloped tank floor 35A and near the shoreward end wall 35S of the tank 35 provides a configuration to trap and remove debris, fish excrement, wasted food etc. from the tank 35 and wherein the return water a low tide flushes the waste matter to the trough 36; an intake/screen and trap turn down 40 to optimum depth for temperature and oxygen level in the ocean 95, the screen keeps trash, ocean plants and other fish and sea creatures from entering the influent pipe 42 to the tank 35; the influent pipe 42 of fish tank system 30; the influent pipe 42C of fish tank system 30 after electro coagulation 80 or after Seawater Reverse Osmosis Systems (SWRO) 90; an airlock relief vent 88 on at high point on influent pipe 42C; an influent pipe drop 43 to tank bottom 35A; Natural coral 92 transplanted and grown in the tank for enhanced habitat; the influent inclined pipe 44 on inclined slope 35A on bottom and sloping up to the to the rear of tank 35R; the supply or influent pipe backflow valve/flap 45 and cage 45A; a cage 46 for the return pipe; the upturn 47 on the return pipe; a wye 48 in the return effluent pipe 50; the backflow valve 49 in the return pipe 50; a protection berm 60 around the tank 35; a moderately sloped truck approach 61; a series of drains 62 between tank 35 and berm 60; a set of at least four (4) cover posts 63 to support a roof/cover 66 and side screens 67; an optional cover 65 with a cover/roof membrane or roof 66; a series of optional side screens 67 (screens and roof supported by conventional structural supports as well as posts 63); a bacteria/slime Reducer 70 (described below in FIG. 6); an Optional Electro Coagulation metals removal system 80 (described below in FIG. 8); a Seawater Reverse Osmosis Systems (SWRO) 90 (described below in FIG. 7); the Ocean 95; and the High Tide and Low Tide level indication on a shoreline S.

The influent pipes 42 and the return effluent pipe 50 are anticipated to be pipe materials and components that do not further contaminate the water. They must also be: suitable for the expected temperatures and pressure; compatible with the water supply, to minimize the potential for electrolytic corrosion; suitable for the ground conditions (if used underground) to minimize the potential for corrosion of the exterior of the pipe; suitable for the local climate (if used outdoors) such freezing conditions or atmospheric salt or Sulphur; and able to withstand UV effects. The materials generally suitable are a Steel alloy, plastic, polybutylene (PB), un-plasticized polyvinylchloride(PVCU), polybutylene (PB), polyethylene (PE or HDPE), polypropylene (PP), cross-linked polyethylene (PEX), and water tight composite material.

The berm 60 is anticipated to be high enough to keep storm water and high seas out of the tanks 35. The berm can be an earthen work built up around the tanks, a concrete or rock brick brat with some sealing sand, a secondary reinforced concrete wall, an asphalt covered mound or the like for economy. The truck ramps are anticipated to be gravel, concrete, asphalt or a composite material used in road beds.

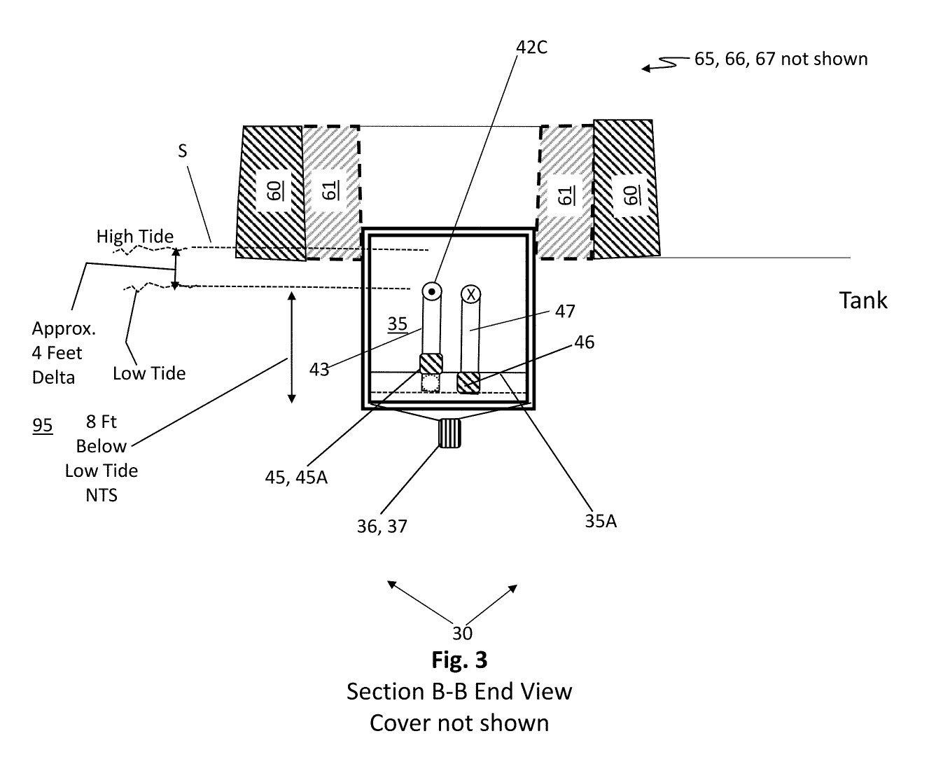

FIG. 3 is a sketch of a sectional view B-B of the saltwater fish raising tank system 30. This depiction is from a generally End View with many of the components and features noted. This view demonstrates: a special fish tank system 30 in which to raise and sell salt-water fish; the main fish tank 35 as an example and not as a limitation approximately 100 feet wide by 300 feet long and essentially 14 to 16 feet deep, with a minimum 12 feet of the tank below high tide and 8 feet of the depth (or more) below low tide—and with a minimum 2 feet of the tank walls above shore line at 200 feet away from the shoreline S at high tide; the tank bottom 35A, sloped from end farthest end from shore 35R downward to sump pit 37 and collection trough 36; a collection trough 36 for securing the waste materials (feed, excrement, etc.) washed down from the tank floor 35A; a sump pit 37 (anticipated to have a draining pipe and pump) in the trough 36; an influent pipe drop 43 to tank bottom 35A; the influent inclined pipe 44 on inclined slope 35A on bottom and sloping up to the to the rear of tank 35R; the supply or influent pipe backflow valve/flap 45 and cage 45A; a cage 46 for the return pipe; the upturn 47 on the return pipe; a protection berm 60 around the tank 35; a moderately sloped truck approach 61; the Ocean 95; and the High Tide and Low Tide level indication on a shoreline S.

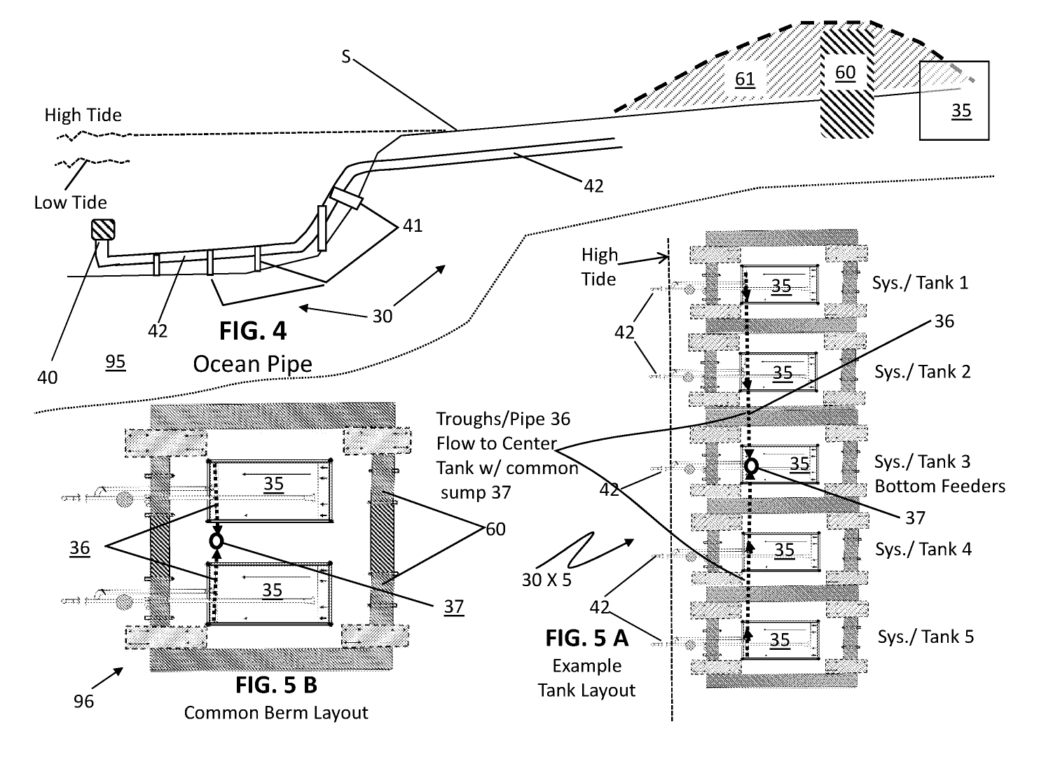

FIG. 4 is a sketch of the saltwater fish raising tank system 30 showing the ocean view of the influent pipe 42. This view shows: a special fish tank system 30 in which to raise and sell salt-water fish; an intake/screen and trap turn down 40 to optimum depth for temperature and oxygen level in the ocean 95, the screen keeps trash, ocean plants and other fish and sea creatures from entering the pipes 42 to the tank 35; a series of ocean and floor supports and anchors 41 to secure piping 42 to floor of ocean 95; the influent pipe 42 of fish tank system 30; a protection berm 60 around the tank 35; a moderately sloped truck approach 61; the Ocean 95; the High Tide and Low Tide level indication; and the shoreline at high tide S.

FIG. 5 A is a sketch of the special fish tank system 30 to raise and sell salt-water fish showing a layout of five systems 30, for example, placed together to save on construction and operation synergies. Shown are the special fish tank systems 30 in which to raise and sell salt-water fish; the main fish tank 35 as an example and not as a limitation approximately 100 feet wide by 300 feet long and essentially 14 to 16 feet deep, with a minimum 12 feet of the tank below high tide and 8 feet of the depth (or more) below low tide—and with a minimum 2 feet of the tank walls above shore line at 200 feet away from the shoreline S at high tide; and the influent pipes 42 of fish tank system 30. One notes the common walls and berms, the ability to join troughs 36; and other synergies. The number of tanks and which components can be combined are shown as examples and not limitations. For example a plurality (more than one tank) and combinations of tank walls 35L; the influent pipes 42 of the fish tank system 30; the covers 65, 66; and other components are anticipated in the various layouts of systems 30 with more than one tank 35. FIG. 5 B is a sketch of the special fish tank system with multiple tanks 35 having a common berm 60.

FIG. 6 shows a sketch of an optional Bacteria/Slime Reducer for the special fish tank system 30 to raise and sell salt-water fish. This drawing of an optional component 70 show features: the influent pipe 42 of fish tank system 30; the influent pipe 42C of fish tank system 30 after the bacteria reducer 70; a protection berm 60 around the tank 35; a cascade/step 71 to divert and spread water in the reducer 70; a power supply 75 for the electrically powered devices in the system 30; and an Ultra Violet, High Intensity Narrow Spectrum, and/or UV Germicidal Irradiation Lights 77. Ultraviolet germicidal irradiation (UVGI) is a disinfection method that uses short-wavelength ultraviolet (UV-C) light to kill or inactivate microorganisms by destroying nucleic acids and disrupting their DNA, leaving them unable to perform vital cellular functions. The UVGI is used in a variety of applications, such as food, air, and water purification. Examples include Pulsed-xenon lamps emit UV light across the entire UV spectrum with a peak emission near 230 nm. A low-pressure mercury-vapor discharge tube floods the inside of a biosafety cabinet with shortwave UV light when not in use, sterilizing microbiological contaminants from irradiated surfaces of bacteria in the intake water.

FIG. 7 shows a sketch of an optional Seawater Reverse Osmosis Systems (SWRO) 90 for the special fish tank system to raise and sell salt-water. Removal of heavy metals dissolved at low concentrations in water and wastewaters is often a problem that can be solved in different ways. Application of reverse osmosis can be an effective way of heavy metal removal. From drinking water-makers to industrial sized Seawater Purification, a SWRO offers a full range of systems. The units are manufactured to eliminate a large amount of salts and other minerals from seawater using RO. The equipment does the filtration by employing a high-pressure pump to salty water forcing it through semi-porous membranes denying salts and other organics from flowing through. The membranes are only tasked to remove dissolved solids while dividing the feed water into purified water and rejected concentrated salts. The salts and other organics are thrown into the brine stream then flushed into a drain. At the end one has purified water that has 99% less dissolved salts. These sea water RO systems have the power to purify extremely high TDS water. Seawater RO systems are usable anywhere from yachts to municipalities and can certainly be an option for the special fish tank system 30 in which to raise and sell salt-water fish. It's important to choose the correct materials of construction to handle seawater (which is highly corrosive). Some manufacturers suggest materials such as Duplex SS 2205, SS 2207 or Monel, and SS 904 to guarantee a longer operating life and less maintenance. Many providers in the industry of water purification has extensive experience desalting seawater all around the world. Their engineers consult for other manufacturers of desalination equipment.

FIGS. 8 A and 8 B show sketches of an optional Electro Coagulation system to remove metals from a Top and View for the special fish tank system 30 to raise and sell salt-water fish. Shown in FIG. 8 A are: the influent pipe 42 of fish tank system 30; the influent pipe 42C of fish tank system 30 after electro coagulation 80; the optional Electro Coagulation metals removal system 80; a plate scraper 81; a plate scraper support 82; an electrolysis dual pair of electrodes Anode and cathode) plate system 83; and the structural support 84. The FIG. 8 B shows a summary of primary reactions and transport in an electrocoagulation reactor. Flocs formed by coagulation are separated by gravity either by sedimentation or rotation. Charged species in solution undergo electrophoretic movement, with negative charge moving toward the anode and positive charge toward the cathode. Electrocoagulation (EC) is the in situ production of coagulant in water by passing electrical charge through one or more submerged, sacrificial electrodes. EC can be modeled as a three-stage process: coagulant formation, contaminant destabilization and flocculation. First, the anode is electrochemically oxidized to release cations in solution: M sub o-oxygen to the S power becomes/forms as M sub aq-aqueous to the Z plus power plus z times e where M is the metal comprising the sacrificial electrode(s), commonly aluminum or iron. These cations combine with hydroxide ligands (an ion or molecule attached to a metal atom by coordinate bonding) to form coagulant in solution. At the same time, hydrogen gas is formed at the cathode by electrolytic reduction of water. Next, the coagulant destabilizes dissolved or colloidal contaminants and physically aggregates to form flocs. Flocs can enmesh with bubbles of hydrogen gas and rise to the surface to form a flotation layer or simply settle out to the bottom by gravitation. These processes are graphically depicted in FIG. 8 B.

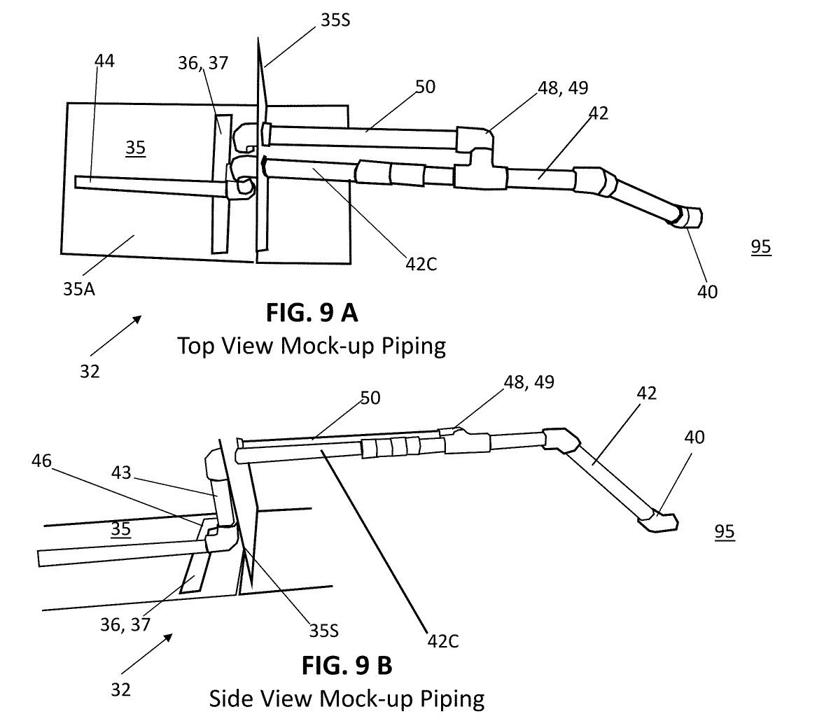

FIGS. 9 A and 9 B are sketches of Mock-up Piping 32 for the special fish tank system 30 to raise and sell salt-water fish. Shown in these sketches are: this is a mock-up piping 32 of special fish tank system 30 to raise and sell salt-water fish; the main fish tank 35 (full size as an example and not as a limitation approximately 100 feet wide by 300 feet long and essentially 14 to 16 feet deep, with a minimum 12 feet of the tank below high tide and 8 feet of the depth [or more] below low tide—and with a minimum 2 feet of the tank walls above shore line at 200 feet away from the shoreline S at high tide); the tank 35 shoreward end wall 35S nearest the shore S; a collection trough 36 for securing the waste materials (feed, excrement, etc.) washed down from the tank floor 35A; a sump pit 37 (anticipated to have a draining pipe and pump) in the trough 36; the influent inclined pipe 44 support 39 from tank 35 inclined bottom 35A; an intake/screen and trap turn down 40 to optimum depth for temperature and oxygen level in the ocean 95, the screen keeps trash, ocean plants and other fish and sea creatures from entering the pipes 42 to the tank 35; the influent pipe 42 of fish tank system 30; the influent pipe 42C of fish tank system 30 after electro coagulation 80 or after Seawater Reverse Osmosis Systems (SWRO) 90; an influent pipe drop 43 to tank bottom 35A; the influent inclined pipe 44 on inclined slope 35A on bottom and sloping up to the to the rear of tank 35R; a cage 46 for the return pipe; a wye 48 in the return pipe 50; the backflow valve 49 in the return pipe 50; and the Ocean 95.

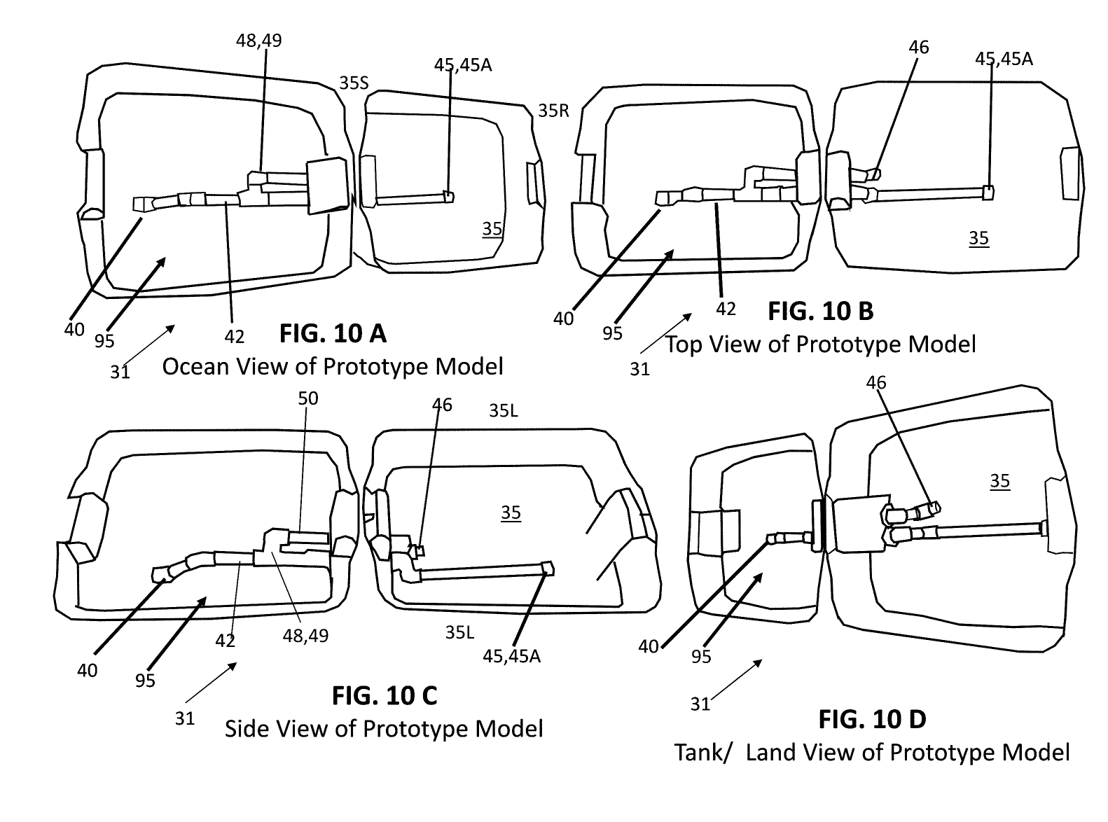

FIGS. 10 A through 10 D are sketches of the Prototype Model 31 for the special fish tank system 30 to raise and sell salt-water fish. Provided in these sketches are: this is a prototype model 31 special fish tank system 30 to raise and sell salt-water fish; the main fish tank 35 [the full sized tank 35 as an example and not as a limitation approximately 100 feet wide by 300 feet long and essentially 14 to 16 feet deep, with a minimum 12 feet of the tank below high tide and 8 feet of the depth (or more) below low tide—and with a minimum 2 feet of the tank walls above shore line at 200 feet away from the shoreline S at high tide]; the tank 35 shoreward end wall 35S nearest the shore S; the tank 35 rearward end wall 35R farthest away from the shore S; the tank 35 walls 35L which are longitudinal walls along each side of tank and run between the end walls 35S and 35R; an intake/Non-Provisional screen and trap turn down 40 to optimum depth for temperature and oxygen level in the ocean 95, the screen keeps trash, ocean plants and other fish and sea creatures from entering the pipes 42 to the tank 35; the influent pipe 42 of fish tank system 30; the influent pipe 42C of fish tank system 30 after electro coagulation 80 or after Seawater Reverse Osmosis Systems (SWRO) 90; the supply or influent pipe backflow valve/flap 45 and cage 45A; a cage 46 for the return pipe; the upturn 47 on the return pipe; a wye 48 in the return pipe 50; the backflow valve 49 in the return pipe 50; and the Ocean 95.

The details mentioned here are exemplary and not limiting. Other specific components and manners specific to describing a saltwater fish raising tank system 30 may be added as a person having ordinary skill in the field of the art of fish raising devices and systems and their uses well appreciates.

### OPERATION OF THE PREFERRED EMBODIMENT

The saltwater fish raising tank system 30 has been described in the above embodiment. The manner of how the device operates is described below. One notes well that the description above and the operation described here must be taken together to fully illustrate the concept of the saltwater fish raising tank system 30. The preferred embodiment a special fish tank system 30 that is comprised of: A special fish tank system 30 that is comprised of: (a) a tank 35 with water tight walls, the tank 35 having a sloped bottom 35A, a rearward end wall 35R that is farthest away from the shore S, a shoreward end wall 35S nearest the shore S, a pair of 35L longitudinal wall 35L along each side of the tank 35; (b) a protection berm 60 that encircles the tank with an interior tank side and an exterior shore and surrounding area side, the berm 60 further comprising a truck approach 61 and service workspace area 64 between the tank 35 and the berm 60 and at least one drain 62 between the tank side and shore side of the berm 60; (c) an influent pipe 42 that runs from the offshore bottom of the ocean 95 to the tank 35, the entry end of the influent pipe 42 in the offshore bottom of the ocean having a cage 40, an elevation drop 43, a section 42C that runs parallel to the sloped tank bottom 35A, and a cage 45 and back flow valve 45A at the farthest end of the tank 35 near the rearward end wall 35R of the tank, wherein the high tide permits and replenishes new seawater to the tank through tidal shifts; (d) an effluent pipe 50 with a cage 46, the pipe 50 runs from the tank 35 near the shoreward end wall 35S, through the berm 60, and through a wye 48 and backflow valve 49 to reconnect with the ocean influent pipe 42 and return the old water from the tank by means of the tidal shift at low tide; and (e) a trough 36 and a sump 37 near the lower part of the sloped tank floor 35A and near the shoreward end wall 35S of the tank 35 to provide a configuration to trap and remove debris, fish excrement, wasted food etc. from the tank 35 whereby the return water a low tide flushes the waste matter to the trough 36 wherein the special fish tank system 30 is used to economically and efficiently raise for commercially for sale salt-water fish and seafood. Optional water filtering devices including a bacteria remover, an electro coagulation machine, and a Seawater Reverse Osmosis Systems (SWRO) are anticipated.

The special fish tank system 30 to raise and sell salt-water fish operates by bring water in from the ocean 95 (high in nutrients) to the tank 35 at high tide and returning the spent or used water (low in nutrients). The influent pipes 42 and return pipes 50 have cages and backflows to protect the flow. The berm 60 and truck 61 approach provides tank protection and a manner to have supply and maintenance trucks get proximate to the tanks 35. Further options (like a bacteria remover 70, an electro coagulation machine 80, and a Seawater Reverse Osmosis Systems (SWRO) 90) provide equipment to further rid the incoming seawater of metals and chemicals—such as mercury, arsenic, etc.—and bacteria and slime harmful to the saltwater fish and seafood creatures.

The FIG. 5, FIGS. 9 A and 9 B sketches of a Mock-up Piping 32, and FIGS. 10 A through 10 D sketches of the Prototype Model 31 provide basic drawings with the system 30 in order to physically understand the operation.

Many uses and options are anticipated for the saltwater fish raising tank system 30. Some examples, and not limitations, are shown in the following Table.

| ITEM | DESCRIPTION |
|---|---|
| 1 | Single Tank systems |
| 2 | Multiple tank system to use synergies and |
| | common components to reduce investment capital |
| | and operational costs |
| 3 | Covered tanks as an option |
| 4 | Metals removal with Electro Coagulation metals |
| | removal system 80 |
| 5 | Slime and bacteria removal with Ultra Violet, |
| | High Intensity Narrow Spectrum, and/or UV |
| | Germicidal Irradiation Lights 77 |
| 6 | Water purification with optional Seawater |
| | Reverse Osmosis Systems (SWRO) 90 |
| 7 | Raise exotic and small saltwater fish for |
| | aquariums |

With this description it is to be understood that the special fish tank system 30 to raise and sell salt-water fish is not to be limited to only the disclosed embodiment of product. The features of the special fish tank system 30 to raise and sell salt-water fish are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

1. A fish tank system (30) that is comprised of:
(a) a tank (35) located along a shore (S) with water tight walls, the tank (35) having a sloped bottom (35A), a rearward end wall (35R) that is farthest away from the shore (S), a shoreward end wall (35S) nearest the shore (S), a pair of (35L) longitudinal walls (35L) along an each side of the tank (35);
(b) a protection berm (60) that encircles the tank with an interior tank side and an exterior shore and surrounding area side, the berm (60) further comprising a truck approach (61) and a service workspace area (64) between the tank (35) and the berm (60) and at least one drain (62) between the tank side and shore side of the berm (60);
(c) an influent pipe (42) that runs from an offshore bottom of an ocean (95) to the tank (35), an entry end of an influent pipe (42) in the offshore bottom of the ocean having a cage (40), an elevation drop (43), a section (42C) that runs parallel to the sloped tank bottom (35A), and a cage (45) and back flow valve (45A) at a farthest end of the tank (35) near the rearward end wall (35R) of the tank, wherein the fish tank system (30) utilizes a high tide to permit and replenish an amount of new seawater to the tank through tidal shifts;
(d) an effluent pipe (50) with a cage (46), the effluent pipe (50) runs from the tank (35) near the shoreward end wall (35S), through the berm (60), and through a wye (48) and backflow valve (49) to reconnect with the ocean influent pipe (42) and return an amount of old, return water from the tank by means of a tidal shift at a low tide; and
(e) a trough (36) and a sump (37) near a lower part of the sloped tank floor (35A) and near the shoreward end wall (35S) of the tank (35) to provide a configuration to trap and remove a waste matter including a debris, a fish excrement, and a wasted food from the tank (35), whereby the amount of old return water in the effluent pipe (50) at the low tide flushes the waste matter to the trough (36),
wherein the fish tank system (30) is used to grow an amount of fish from small to adult size for commercial sales of salt-water fish and seafood.

2. The fish tank system (30) according to claim 1 further comprising a water filtering device including a bacteria remover (70).

3. The fish tank system (30) according to claim 1 further comprising an electrocoagulation machine (80).

4. The fish tank system (30) according to claim 1 further comprising a Seawater Reverse Osmosis System (SWRO) (90).

5. The fish tank system (30) according to claim 1 further comprising a set of corner posts (63), a cover (65, 66) and a set of side screens (67).

6. The fish tank system (30) according to claim 1 wherein a material for constructing the tank (35) with water tight walls is selected from the group consisting of a reinforced concrete, a masonry block, a precast concrete, a steel with watertight liners and an earthen work with watertight liners.

7. The fish tank system (30) according claim 1 wherein the influent pipe (42) is selected from the group consisting of steel alloy, plastic, polybutylene (PB), un-plasticized polyvinylchloride(PVCU), polyethylene (PE), high-density polyethylene (HDPE), polypropylene (PP), cross-linked polyethylene (PEX), and water tight composite material.

8. The fish tank system (30) according to claim 1 wherein the berm (60) is selected from the group consisting of an earthen work built up around the tanks, a concrete brick brat, a rock brick brat with some sealing sand, a secondary reinforced concrete wall, and an asphalt covered mound.

9. The fish tank system 30 according to claim 1 wherein the truck approach (61) is selected from the group consisting of a gravel, a concrete, and an asphalt.

10. The fish tank system (30) according to claim 1 wherein the effluent pipe (50) are selected from the group consisting of steel alloy, plastic, polybutylene (PB), un-plasticized polyvinylchloride(PVCU), polyethylene (PE), high-density polyethylene (HDPE), polypropylene (PP), cross-linked polyethylene (PEX), and water tight composite material.

11. At least two fish tank systems (30) described in claim 1 wherein the at least two systems are connected with a single, common trough (36) and a sump (37).

12. At least two fish tank systems (30) described in claim 1 wherein the at least two tanks (35) are surrounded by a single, common berm (60).

13. A fish tank system (30) that is comprised of:
(a) a tank (35) located along a shore (S) with water tight, reinforced concrete walls, the tank (35) having a sloped bottom (35A), a rearward end wall (35R) that is farthest away from a shore (S), a shoreward end wall (35S) nearest the shore (S), a pair of (35L) longitudinal walls (35L) along an each side of the tank (35);
(b) a single earthen protection berm (60) that encircles the tank with an interior tank side and an exterior shore and surrounding area side, the berm (60) further comprising a paved truck approach (61) and a service workspace area (64) between the tank (35) and the berm (60) and at least one drain (62) between the tank side and shore side of the berm (60);
(c) a plastic influent pipe (42) that runs from an offshore bottom of an ocean (95) to the tank (35), an entry end of an influent pipe (42) in the offshore bottom of the ocean having a cage (40), an elevation drop (43), a section (42C) that runs parallel to the sloped tank bottom (35A), and a cage (45) and back flow valve (45A) at a farthest end of the tank (35) near the rearward end wall (35R) of the tank, wherein the fish tank system (30) utilizes a high tide to permit and replenish an amount of new seawater to the tank through tidal shifts;
(d) a plastic effluent pipe (50) with a cage (46), the effluent pipe (50) runs from the tank (35) near the shoreward end wall (35S), through the berm (60), and through a wye (48) and backflow valve (49) to reconnect with the ocean influent pipe (42) and return an amount of old, return water from the tank by means of a tidal shift at a low tide;
(e) a trough (36) and a sump (37) near a lower part of the sloped tank floor (35A) and near the shoreward end wall (35S) of the tank (35) to provide a configuration to trap and remove a waste matter including a debris, a fish excrement, and a wasted food from the tank (35), whereby the amount of old return water in the effluent pipe (50) at the low tide flushes the waste matter to the trough (36); and
(f) a water filtering device including a bacteria remover (70)
wherein the fish tank system (30) is used to grow an amount of fish from small to adult size for commercial sales of salt-water fish and seafood.

14. The fish tank system (30) according to claim 13 wherein the plastic influent pipe (42) is selected from the group consisting of polybutylene (PB), polyvinylchloride(PVC), polyethylene (PE), high-density polyethylene(HDPE), polypropylene (PP), cross-linked polyethylene (PEX), and water tight plastic composite material.

15. The fish tank system (30) according to claim 13 wherein the plastic effluent pipe (50) is selected from the group consisting of polybutylene (PB), polyvinylchloride(PVC), polyethylene (PE), high-density polyethylene(HDPE), polypropylene (PP), cross-linked polyethylene (PEX), and water tight plastic composite material.
